(19) United States
(12) Patent Application Publication
(10) Pub. No.: US 2004/0235230 A1
(43) Pub. Date: Nov. 25, 2004

(54) Crystal growth apparatus and crystal growth method for semiconductor thin film

(76) Inventors: Tetsuya Inui, Nara-shi (JP); Yoshihiro Taniguchi, Tenri-shi (JP); Masanori Seki, Tenri-shi (JP)

Correspondence Address: EDWARDS & ANGELL, LLP, P.O. BOX 55874, BOSTON, MA, 02205, US

(21) Appl. No.: 10/789,085

(22) Filed: Feb. 27, 2004

(30) Foreign Application Priority Data
Feb. 28, 2003 (JP) 2003-053376( P )

(51) Int. Cl. G02B 13/20

(52) U.S. Cl. 438/200

(57) ABSTRACT

A crystal growth apparatus for a semiconductor thin film includes a first radiator for selectively radiating first laser light to the semiconductor thin film for allowing semiconductor thin film to crystallize through a super-lateral growth method and a second radiator for selectively radiating second laser light, which is transmitted through the semiconductor thin film better than the first laser light, to the glass substrate at a position corresponding to an area including a crystallization target area of semiconductor thin film. The second radiator includes a laser oscillator for producing the second laser light, an aperture stop plate being radiated with the second laser light to form a desired aperture image, and an objective lens for forming the aperture image on the main surface of the glass substrate. Thus, a polycrystalline semiconductor thin film having large crystal grains can easily and stably be obtained.

This nonprovisional application is based on Japanese Patent Application No. 2003-053376 filed with the Japan Patent Office on Feb. 28, 2003, the entire contents of which are hereby incorporated by reference.

### BACKGROUND OF THE INVENTION

1. Field of the Invention

The present invention relates to a crystal growth apparatus and a crystal growth method for a semiconductor thin film using an energy beam such as laser light.

2. Description of the Background Art

In recent years, a flat type display apparatus employing liquid crystal or organic electroluminescence (organic EL) is used widely in a display of a personal computer or a mobile phone. In such a display apparatus using liquid crystal or organic EL, a thin film transistor is used in which amorphous or polycrystalline silicon is employed as an active layer in order to switch pixel display. Specifically, by forming such a thin film transistor on a glass substrate, and further forming a liquid crystal device or an organic EL device on the glass substrate, a thin and lightweight display apparatus can be manufactured.

Among others, a thin film transistor formed using a polycrystalline silicon thin film has greater advantages over a thin film transistor formed using amorphous silicon, because of its higher mobility of carriers (electrons) over that of the thin film transistor formed using amorphous silicon.

For example, its high mobility of carriers enables to manufacture a transistor of high performance. Accordingly, it enables to form not only a switching element in a pixel portion but also a driving circuit or an image processing circuit in a peripheral region of a pixel, which require transistors of high performance. As a result, a driver IC (Integrated Circuit), a circuit board and the like are no longer necessary to be mounted on a glass substrate separately, and thus the display apparatus can be provided at low cost.

Another advantage is the capability of scaling down a transistor. As the switching element formed in the pixel portion can be reduced in size, numerical aperture can be made higher. As a result, a display apparatus with high luminance and high precision can be provided.

When forming a polycrystalline silicon thin film, generally, a method is employed in which an amorphous silicon thin film is formed on a glass substrate through CVD (Chemical Vapor Deposition) or the like, and thereafter the amorphous silicon thin film is made polycrystalline.

One method for making the amorphous silicon thin film polycrystalline is an annealing method, in which the entire base material is held under a high temperature of 600° C.-1000° C. or higher, thereby melting the amorphous silicon thin film, and then allowing recrystallization. In this case, a base material that can withstand the temperature of at least 600° C. must be used, which necessitates using an expensive quartz substrate. This has been an obstacle for reducing the cost of the apparatus.

In recent years, however, a technique for making an amorphous silicon thin film polycrystalline using laser light at a low temperature of at most 600° C. is becoming common, and it is now possible to make an amorphous silicon thin film polycrystalline using an inexpensive glass substrate.

In a crystallization technique using laser light, a general method is heating a glass substrate on which an amorphous silicon thin film is formed to about 400° C., and radiating the glass substrate with a linear beam having a length of 200 mm-400 mm and a width of about 0.2 mm-1.0 mm while scanning the glass substrate at a constant speed. According to the method, a crystal grain having a grain size of about 0.2 μm-0.5 μm can be obtained.

It is noted that the amorphous silicon thin film radiated with the laser light does not melt throughout its thickness, but leaves some portions amorphous. Accordingly, the nuclei of crystals will be generated all over the area radiated with the laser light, and the crystals will grow to the top surface of the silicon thin film, whereby crystal grains with irregular orientation is formed.

According to this method, however, as many crystal grains are formed on the glass substrate, numerous grain boundaries will be present in a thin film. Thus, when a transistor is formed in the polycrystalline silicon thin film, carriers are scattered by the grain boundaries and mobility thereof is degraded to the extent of a fraction of the mobility of a monocrystalline silicon substrate. Accordingly, in order to obtain a transistor of higher performance, it is necessary to increase the grain size of polycrystalline silicon thin film, and to control the crystalline orientation. Thus, in recent years, many studies and developments have been made in order to obtain a silicon thin film that is similar to monocrystalline silicon.

One of such developments is the technique disclosed in, for example, Japanese Patent Laying Open Nos. 11-307450 and 58-201326. In the technique disclosed therein, laser light for heating the glass substrate is used in addition to the laser light for melting the amorphous silicon thin film. This enables to heat the glass substrate locally, whereby a crystal grain that is larger than the conventional crystal grain can be obtained. However, even with the technique disclosed in the references, the crystal grain cannot be increased in size dramatically, and further studies and developments are required.

Japanese Patent National Publication No. 2000-505241 discloses a technique referred to as a super-lateral growth method. In the crystal growth method disclosed therein, a slit-shaped pulsed laser is radiated to the silicon thin film, whereby the silicon thin film is melted and solidified throughout the thickness of the area radiated with the laser and thus crystallized. In the following, the super-lateral growth method is described in detail with reference to the drawings.

FIG. 18 is a schematic view representing an acicular crystal structure formed by a single-time pulse radiation. For example, by radiating a slit-shaped pulse having a width of 2 μm-3 μm, a crystallization target area 22 melts, crystals grow in the lateral direction from the boundaries of the melted area, i.e., in the direction parallel to the main surface of the glass substrate (the direction indicated by an arrow 24), and the crystals grown from opposite sides collide at the central portion of the melted area, thereby terminating the growth. The crystal growth in the direction indicated by arrow 24 is referred to as the super-lateral growth. Though it may vary depending on various process conditions, the length of a crystal obtained through this method has been found to be about 1.2 μm at most when an excimer laser light having a wavelength of 308 nm is used at a substrate temperature of 300° C. (See Akito Hara, Nobuo Sasaki, “Nucleus formation site of silicon on glass and solidification direction control—aiming to form monocrystalline silicon Si-TFT”, Textbook of the 112th workshop of Division of Materials Science and Crystal Technology of the Japan Society of Applied Physics, Division of Materials Science and Crystal Technology of the Japan Society of Applied Physics, Jun. 20, 2000, pp. 19-25.)

Further, as a method for increasing the length of a crystal, there is a super-lateral method using a plurality of times of pulse radiation. In this super-lateral method using a plurality of times of pulse radiation, the laser pulse is sequentially radiated so as to overlap part of acicular crystal formed by the immediately preceding laser radiation. This allows a longer acicular crystal to grow successively from the crystal that has already grown. As a result, acicular crystal grains larger in size and with regular orientation along the growth direction of the crystals can easily be obtained as compared to crystallization through the single-time pulse radiation.

In this case, assuming that the crystal of about 1.2 μm as described above can be obtained from single-time pulse radiation, it is expected that a crystal of about 5 μm-10 μm can be obtained by repeating radiation, while shifting the slit for passing through the laser by about 0.6 μm. The expected length may vary depending on the times of successive growth caused by shifting the slit.

However, the size of the crystal grain obtained from any of the techniques described above is still not sufficiently large.

### SUMMARY OF THE INVENTION

The present invention is to provide a crystal growth apparatus and a crystal growth method for a semiconductor thin film in which a polycrystalline semiconductor thin film having a larger crystal grain can easily and stably be obtained, and specifically, to provide a crystal growth apparatus and a crystal growth method for a semiconductor thin film that can greatly increase the size of a crystal grain that can be obtained with a single-time laser light radiation in a super-lateral growth method.

A crystal growth apparatus for a semiconductor thin film according to the present invention is for radiating laser light to a semiconductor thin film formed on a base material to cause crystal growth of the semiconductor thin film in a direction substantially parallel to a main surface of the base material, and includes a first radiator and a second radiator. The first radiator is for selectively radiating first laser light to the semiconductor thin film to melt a crystallization target area of the semiconductor thin film. The second radiator is for selectively radiating second laser light, which is transmitted through the semiconductor thin film better than the first laser light, to the base material, to heat the base material at a position corresponding to an area including the crystallization target area of the semiconductor thin film. The second radiator includes a light source for producing the second laser light, an aperture stop plate being radiated with the second laser light to form a desired aperture image, and an objective lens for forming the aperture image on the main surface of the base material.

Thus, by causing the super-lateral growth using the first radiator for melting the semiconductor thin film and the second radiator for delaying solidification of the melted semiconductor film, crystallization of the semiconductor thin film can be delayed. Thus, the size of the crystal being formed can be increased greatly. Further, by shaping the aperture image using the aperture stop plate, the radiation area of the second laser light radiated to the base material can be adjusted appropriately. Accordingly, it will be possible to uniformly radiate the second laser light over the entire radiated area of the base material, whereby the entire radiated area of the base material can uniformly be heated. As a result, the crystal grains formed in the semiconductor thin film can easily be increased in size.

In the crystal growth apparatus for a semiconductor thin film according to the present invention as described above, for example, preferably the second radiator further includes irradiance distribution uniformizing structure arranged between the aperture stop plate and the light source for adjusting the second laser light such that the second laser light being transmitted attains uniform irradiance distribution on a plane perpendicular to its optical axis.

Thus, by providing the irradiance uniformizing structure to the second radiator for heating the base material, the entire radiated area of the base material can uniformly be heated, and large crystal grains can stably be obtained.

In the crystal growth apparatus for a semiconductor thin film according to the present invention as described above, for example, preferably the second radiator is configured such that the second laser light is obliquely incident on the main surface of the base material, the objective lens is arranged substantially perpendicular to an optical axis of the obliquely incident second laser light, and the aperture stop plate is arranged obliquely to the optical axis of the obliquely incident second laser light such that an image plane of the aperture image substantially overlays the main surface of the base material.

Thus, by the configuration where the image plane of the aperture image substantially overlays the main surface of the base material when the second laser light is obliquely incident, the entire radiated area of the base material can uniformly be heated, and large crystal grains can stably be obtained.

In the crystal growth apparatus for a semiconductor thin film according to the present invention as described above, for example, preferably an aperture provided to the aperture stop plate is adjusted to be in a trapezoidal shape such that the aperture image formed on the main surface of the base material becomes a quadrangular shape.

Thus, by adjusting the radiated area by the second radiator to be in a quadrangular shape when the second laser light is obliquely incident, the entire radiated area of the base material can uniformly be heated even when crystals are caused to grow continuously by a plurality of times of pulsed radiation, and large crystal grains can stably be obtained.

In the crystal growth apparatus for a semiconductor thin film according to the present invention as described above, for example, preferably the second radiator is configured such that the second laser light is obliquely incident on the main surface of the base material, and the objective lens and the aperture stop plate are arranged substantially parallel to the main surface of the base material.

With such a configuration, the entire radiated area of the base material can uniformly be heated, whereby large crystal grains can stably be obtained.

Among the crystal growth apparatuses for a semiconductor thin film according to the present invention as described above, in the crystal growth apparatus for a semiconductor thin film where the second laser light is obliquely incident on the main surface of the base material, for example, preferably the second radiator further includes irradiance distribution uniformizing structure arranged between the aperture stop plate and the light source for adjusting the second laser light such that the second laser light being transmitted attains uniform irradiance distribution on a plane perpendicular to its optical axis.

Thus, even when the second laser light is obliquely incident, by providing irradiance uniformizing structure to the second radiator for heating the base material, the entire radiated area of the base material can uniformly be heated, whereby large crystal grains can stably be obtained.

Among the crystal growth apparatuses for a semiconductor thin film according to the present invention as described above, in the crystal growth apparatus for a semiconductor thin film where the second laser light is obliquely incident on the main surface of the base material, for example, preferably the second radiation structure further includes a radiation direction changer arranged substantially parallel to the aperture stop plate for changing radiation direction of the second laser light such that the second laser light output from the irradiance distribution uniformizing structure is obliquely incident on the aperture stop plate.

With such a structure, even when the aperture stop plate is arranged obliquely to the optical axis of the second laser light, the irradiance distribution is made uniform. Thus, the entire radiated area of the base material can uniformly be heated, whereby large crystal grains can stably be obtained. It is noted that, in the crystal growth apparatus for a semiconductor thin film having the radiation direction changer as described above, for example, the radiation direction changer is preferably a prism or a lens.

A crystal growth method for a semiconductor thin film is for radiating laser light to a semiconductor thin film formed on a base material to cause crystal growth of the semiconductor thin film in a direction substantially parallel to a main surface of the base material, and includes the following steps of:

(a) selectively radiating first laser light to the semiconductor thin film to melt a crystallization target area of the semiconductor thin film; and

(b) heating the base material by selectively radiating second laser light to the base material through an aperture stop plate and forming an aperture image shaped by the aperture stop plate on the base material at a position corresponding to an area including the crystallization target area of the semiconductor thin film, wherein the second laser light being transmitted through the semiconductor thin film better than the first laser light.

Thus, in addition to the step of radiating the first laser light for melting the semiconductor film, by further including the step of radiating the second laser light for delaying solidification of the melted semiconductor film, crystallization of the semiconductor thin film can be delayed, and the crystals being formed can greatly be increased in size. Further, by forming the aperture image using the aperture stop plate, the radiated area of the base material by the second laser light can appropriately be adjusted. Accordingly, the entire radiated area of the base material can uniformly be radiated with the second laser light, whereby the entire radiated area of the base material can uniformly be heated. As a result, crystal grains formed in the semiconductor thin film can easily be increased in size.

In the crystal growth method according to the present invention as described above, for example, preferably a radiation period of the second laser light is longer than a radiation period of the first laser light, and the radiation period of the second laser light includes a period coinciding with the radiation period of the first laser light.

Thus, by adjusting the radiation period, large crystal grains can be obtained further stably.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing the overall configuration of a crystal growth apparatus for a semiconductor thin film according to a first embodiment of the present invention.

FIG. 2 is a schematic view showing an exemplary configuration of second radiation means of the crystal growth apparatus for a semiconductor thin film shown in FIG. 1.

FIG. 3 is a schematic plan view including a crystallization target area of the semiconductor thin film representing a crystal growth method for a semiconductor thin film according to the first embodiment of the present invention.

FIG. 4 is a schematic cross-sectional view including a crystallization target area of the semiconductor thin film representing a crystal growth method for a semiconductor thin film according to the first embodiment of the present invention.

FIG. 5 is a plan view showing the shape of a mask according to the first embodiment of the present invention.

FIGS. 6A-6C are schematic views showing in stages the manner of the growth of acicular crystal grains through a super-lateral growth method using a plurality of times of pulse radiation.

FIG. 7 is a schematic view showing a transistor being formed on the semiconductor thin film formed through the method represented by FIGS. 6A-6C.

FIG. 8 is a plan view showing the shape of a mask according to another example of the first embodiment of the present invention.

FIG. 9 is a plan view showing the state after a semiconductor thin film is crystallized in another example of the first embodiment of the present invention.

FIG. 10 is a plan view showing the state after a transistor is formed in another example of the first embodiment of the present invention.

FIG. 11 is a schematic view of an exemplary configuration of second radiation means of a crystal growth apparatus for a semiconductor thin film according to a second embodiment of the present invention.

FIG. 12A is a schematic view showing the shape of an aperture stop plate of the crystal growth apparatus for a semiconductor thin film according to the second embodiment of the present invention.

FIG. 12B is a schematic view showing the shape of an aperture image when the aperture stop plate having the shape shown in FIG. 12A is used.

FIG. 13 is a schematic view showing an exemplary configuration of second radiation means of a crystal growth apparatus for a semiconductor thin film according to a third embodiment of the present invention.

FIG. 14 is a schematic view showing another exemplary configuration of the second radiation means of the crystal growth apparatus for a semiconductor thin film according to the third embodiment of the present invention.

FIG. 15 is a schematic view showing an exemplary configuration of second radiation means of a crystal growth apparatus for a semiconductor thin film according to a fourth embodiment of the present invention.

FIG. 16 is a schematic view showing an exemplary configuration of second radiation means of a crystal growth apparatus for a semiconductor thin film according to a fifth embodiment of the present invention.

FIG. 17 is a schematic view showing another exemplary configuration of the second radiation means of the crystal growth apparatus for a semiconductor thin film according to the fifth embodiment of the present invention.

FIG. 18 is a schematic view representing an acicular crystal structure formed by a single-time pulse radiation in a conventional super-lateral growth method.

### DESCRIPTION OF THE PREFERRED EMBODIMENTS

The inventors made the present invention focusing attention to the super-lateral growth method in crystallizing a semiconductor thin film using a laser annealing method, and noting that a larger crystal grain is formed in the semiconductor thin film by uniformly heating a base material in an area corresponding to a crystallization target area of the semiconductor thin film.

In the following, embodiments of the present invention will be described with reference to the drawings.

### FIRST EMBODIMENT

(Overall Structure of Crystal Growth Apparatus for Semiconductor Thin Film)

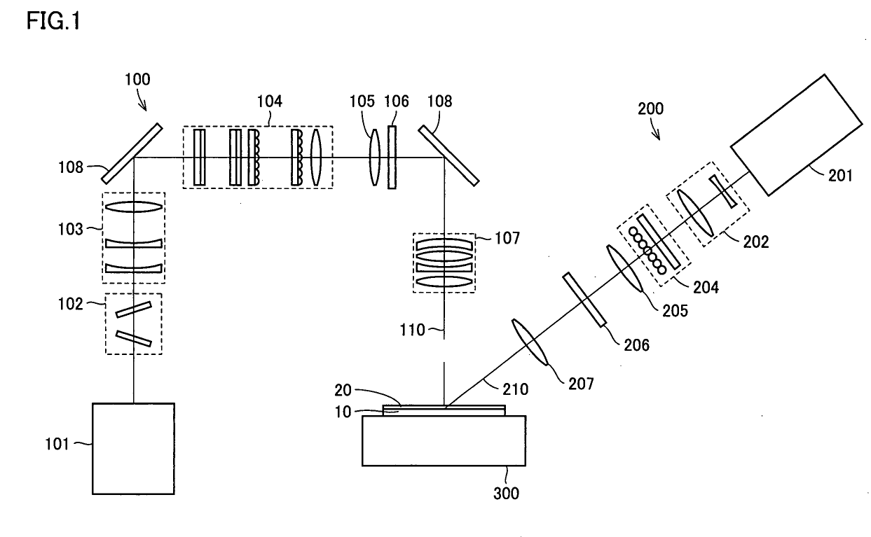

First, referring to FIG. 1, the overall configuration of a crystal growth apparatus for a semiconductor thin film according to the present embodiment is described. As shown in FIG. 1, the crystal growth apparatus for a semiconductor thin film according to the present embodiment includes first radiation means 100, second radiation means 200, and a stage 300.

On stage 300, a glass substrate 10 as a base material is placed. On a main surface of glass substrate 10, a semiconductor thin film 20 is formed in advance in a previous step. An amorphous silicon thin film, a polycrystalline silicon thin film or the like is applicable as semiconductor thin film 20.

(Configuration of First Radiation Means)

First radiation means 100 mainly includes a laser oscillator 101, variable damping means 102, beam shaping means 103, irradiance distribution uniformizing means 104, a field lens 105, a mask 106, an objective lens 107, and a reflecting mirror 108.

Laser oscillator 101 produces first laser light 110. First laser light 110 is pulsed laser light that can melt semiconductor thin film 20. As first laser light 110, laser light is used that has a wavelength in the ultraviolet region such as various solid-state laser light as represented by, for example, excimer laser light or YAG (Yttrium-Aluminum-Garnet) laser light.

Variable damping means 102 is means for correcting the beam intensity of first laser light 110. Beam shaping means 103 is means for correcting the beam shape of first laser light 110. Further, irradiance distribution uniformizing means 104 is means for making uniform the irradiance distribution of first laser light 110 on a plane perpendicular to its optical axis. Irradiance distribution uniformizing means 104 is configured by, for example, combining a cylindrical lens array and a condenser lens, for making the irradiance distribution uniform by once dividing laser light having Gaussian irradiance distribution on a plane perpendicular to its optical axis, and thereafter combining together.

Field lens 105 is a lens for radiating mask 106 with first laser light 110 that has been transmitted through irradiance distribution uniformizing means 104. Mask 106 has a plurality of slits at its main surface for transmitting beams, and it is means for blocking laser light applied to portions where slits do not exist. Objective lens 107 is means for forming an image of a beam that has been transmitted through the slit of mask 106 as a mask image on semiconductor thin film 20.

Reflecting mirror 108 is means for changing the radiation direction of first laser light 110, and can be configured with elements other than the mirror, for example with a lens or the like. Reflecting mirror 108 is only required to be arranged according to optical design or mechanical design of the apparatus, and the place and the numbers of installation are not specifically limited.

(Configuration of Second Radiation Means)

Second radiation means 200 mainly includes a laser oscillator 201 as a light source, beam magnifing means 202, irradiance distribution uniformizing means 204, a field lens 205, an aperture stop plate 206, and an objective lens 207.

Laser oscillator 201 produces second laser light 210. Second laser light 210 is pulsed laser light that can heat glass substrate 10. As second laser light 210, for example carbon dioxide gas laser light or YAG laser light may be used. Here, it should be noted that it is necessary to employ the laser light that is transmitted through semiconductor thin film 20 formed on glass substrate 10 better than first laser light 110 radiated by first radiation means 100.

Beam magnifying means 202 is means for magnifying second laser light 210 produced from laser oscillator 201 to be parallel rays. As beam magnifying means 202, for example a Galilean type beam magnifier is employed.

Irradiance distribution uniformizing means 204 is means for making uniform the irradiance distribution of second laser light 210 on a plane perpendicular to its optical axis. Irradiance distribution uniformizing means 204 is configured by, for example, combining a cylindrical lens array and a condenser lens, for making the irradiance distribution uniform by once dividing laser light having Gaussian irradiance distribution on a plane perpendicular to the optical axis and thereafter combining together.

Field lens 205 is a lens for radiating aperture stop plate 206 with second laser light 210 that has been transmitted through irradiance distribution uniformizing means 204. Aperture step plate 206 has an aperture at its main surface, and it is means for regulating the quantity of light of radiated second laser light 210 and for forming a desired aperture image. Objective lens 207 is means for forming an image of second laser light 210 that has been regulated by aperture stop plate 206 as an aperture image on glass substrate 10.

As means for changing the radiation direction of second laser light 210, a reflecting mirror, a lens, a prism or the like may be arranged, as necessary. These radiation direction changing means are only required to be arranged according to optical design or mechanical design of the apparatus, and the place and the numbers of installation are not specifically limited.

(Relationship Between Arrangement of Optical Systems and Optical Path of Laser Light)

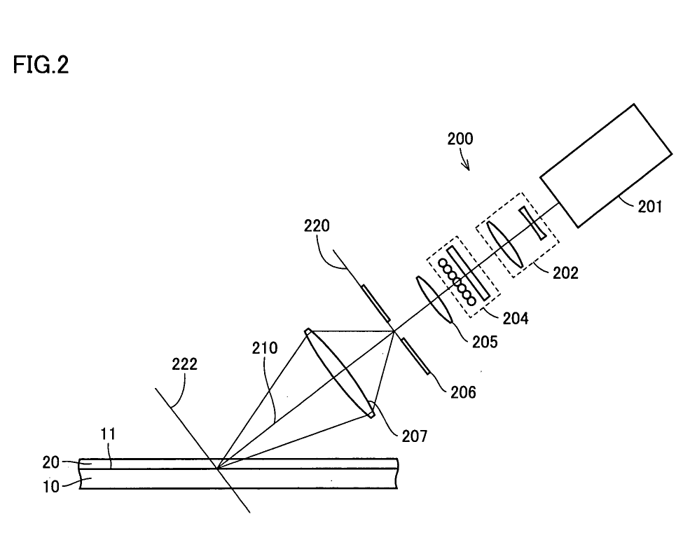

Next, referring to FIG. 2, the relationship between arrangement of optical systems in second radiation means 200 as described above and the optical path of second laser light 210 is described in further detail.

As shown in FIG. 2, in the crystal growth apparatus for a semiconductor thin film according to the present embodiment, second laser light 210 radiated from second radiation means 200 is arranged to be obliquely incident on the main surface of glass substrate 10. On the optical axis of second laser light 210, the optical systems described above are arranged. In the present embodiment, among those optical systems, aperture stop plate 206 and objective lens 207 are arranged so as to be substantially perpendicular to the optical axis of second laser light 210.

Second laser light 210 produced from laser oscillator 201 is adjusted by beam magnifying means 202 to be an appropriate shape on a plane perpendicular to the optical axis of second laser light 210, and adjusted to be parallel rays and radiated to irradiance distribution uniformizing means 204. Second laser light 210, of which irradiance distribution is made uniform on a plane perpendicular to the optical axis by irradiance distribution uniformizing means 204, is radiated to aperture stop plate 206 through field lens 205. Second laser light 210 transmitted through the aperture provided in aperture stop plate 206 is selectively radiated to a prescribed area of a main surface 11 of glass substrate 10 by objective lens 207.

As a result, the plane to which aperture stop plate 206 arranged acts as an object plane 220, and an image of an object positioned on object plane 220, i.e., the image of aperture stop plate 206 (an aperture image) is formed on an image plane 222 by objective lens 207. By arranging the positions of optical systems such that image plane 222 crosses with main surface 11 of glass substrate 10 on the optical axis, the aperture image is formed on main surface 11 of glass substrate 10, and then glass substrate 10 is heated at a portion where the aperture image is formed.

As described above, second laser light 210 is adjusted to laser light that is transmitted through semiconductor thin film 20 formed on glass substrate 10 better. Accordingly, little second laser light 210 is absorbed by semiconductor thin film 20, and therefore glass substrate 10 can be heated effectively.

(Crystal Growth Method for Semiconductor Thin Film)

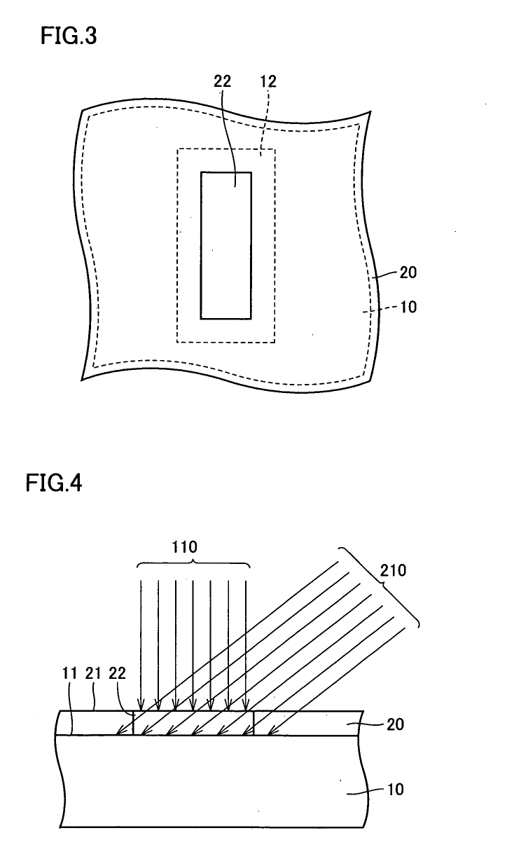

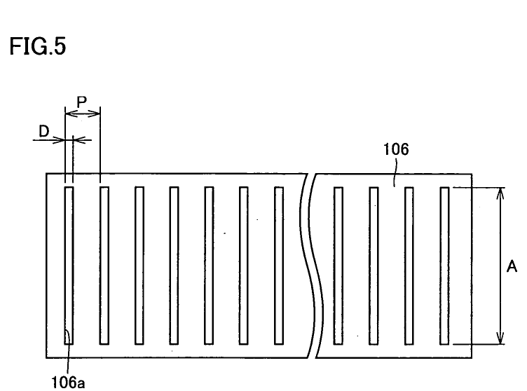

Next, referring to FIGS. 3 and 4, a crystal growth method for a semiconductor thin film according to the present embodiment is described.

As shown in FIGS. 3 and 4, on main surface 11 of glass substrate 10, semiconductor thin film 20 is formed in advance in a previous step. As in the present embodiment it is assumed to apply the super-lateral growth method, crystallization target area 22 of semiconductor thin film 20 is adjusted to a narrow width of, for example, about 2 μm-10 μm. Though the length of crystallization target area 22 is not specifically limited, it should be adjusted to be greater than the width described above. Crystallization target area 22 of semiconductor thin film 20 is radiated with first laser light 110 using first radiation means 100 described above.

As shown in FIG. 4, a radiated area 12 of glass substrate 10 radiated with second laser light 210 by second radiation means 200 is adjusted to include the area corresponding to crystallization target area 22 of semiconductor thin film 20 described above. Specifically, as shown in FIG. 3, when glass substrate 10 and semiconductor thin film 20 are seen two-dimensionally, crystallization target area 22 of semiconductor thin film 20 is adjusted to overlay radiated area 12 of glass substrate 10.

As shown in FIG. 3, first laser light 110 radiated by first radiation means 100 is configured to be incident on main surface 21 of semiconductor thin film 20 substantially perpendicularly. On the other hand, second laser light 210 radiated by second radiation means 200 to glass substrate 10 is configured to be obliquely incident on the main surface of glass substrate 10.

Next, a procedure for crystallizing the semiconductor thin film is described. The crystal growth method for semiconductor thin film according to the present invention mainly includes the steps of: selectively radiating first laser light 110 to semiconductor thin film 20 to melt crystallization target area 22 of semiconductor thin film 20; and heating glass substrate 10 by selectively radiating second laser light 210 that is transmitted through semiconductor thin film 20 better than first laser light 110 to glass substrate 10 through aperture stop plate 206, and forming an aperture image shaped by aperture stop plate 206 on glass substrate 10 at the position corresponding to the area including crystallization target area 22 of semiconductor thin film 20.

Specifically, first, glass substrate 10 is heated by second radiation means 200. At this time, the radiation amount of second laser light 210 from second radiation means 200 is adjusted to the extent that semiconductor thin film 20 is not melted by the heat generated at glass substrate 10. Subsequently, maintaining heating of glass substrate 10 by second radiation means 200, crystallization target area 22 of semiconductor thin film 20 is heated by first radiation means 100 and melted. At the time point when crystallization target area 22 of semiconductor thin film 20 is fully melted, radiation by first radiation means lO0 is terminated. For a prescribed time period from this time point, heating of glass substrate 10 by second radiation means 200 is continued. Thus, crystallization of semiconductor thin film 20 is completed.

By radiating first laser light 110 and second laser light 210 according to this procedure, the super-lateral growth takes place in the semiconductor thin film. In the super-lateral growth method, the semiconductor thin film of the area heated by the slit-shaped pulsed laser (first laser light) is melted, crystals grow in the lateral direction from the boundary between a not-melted area, i.e., in a direction substantially parallel to the main surface of the glass substrate, and then crystals grown from opposite sides collides with each other at the central portion of the melted area, whereby the crystal growth is terminated. In the super-lateral growth method, melting and solidification take place throughout the thickness of the semiconductor thin film.

While radiation of first laser light 110 by first radiation means 100 is initiated after radiation of second laser light 210 by second radiation means 200 is initiated, at least the radiation period of second laser light 210 must be adjusted to include and to be longer than the radiation period of first laser light 110. Specifically, the radiation period of second laser light 210 is adjusted to be longer than that of first laser light 110 and to include a period that coincides with the radiation period of first laser light 110. Thus, the crystallization target area of semiconductor thin film 20 will appropriately maintain the melted state for a long period, delaying the progress of crystallization. Here, it is noted that if second laser light 210 is radiated for a long period, the temperature of glass substrate 10 may increase excessively and thus damage glass substrate 10. Therefore, the radiation period of second laser light 210 must be adjusted to the extent not damaging glass substrate 10.

(Effect)

By crystallizing semiconductor thin film 20 using the crystal growth apparatus and crystal growth method for a semiconductor thin film as described above, the size of crystal grains obtained from single-time radiation can greatly be increased. This is because of the delayed cooling speed of the portion melted by first radiation means 100, which is caused by glass substrate 10 being heated by second radiation means 200, i.e., because of melted semiconductor thin film 20 solidifying slowly.

Here, in the present embodiment, the area radiated by second laser light 210 is defined using aperture stop plate 206. This enables to optimize radiated area 12 by second laser light 210 on glass substrate 10 easily. As a result, the entire radiated area 12 on glass substrate 10 can uniformly be radiated by second laser light 210, and therefore the entire radiated area 12 on glass substrate 10 can uniformly be heated. Accordingly, the crystal grains formed in semiconductor film 20 can be increased in size easily.

Additionally, since in the present embodiment the laser light that is transmitted through semiconductor thin film 20 better than first laser light 110 is employed as second laser light 210, second laser light 210 is less absorbed by semiconductor thin film 20, enabling for semiconductor thin film 20 of glass substrate 10 to be heated locally at the vicinity of the interface. Accordingly, crystallization of the melted portion of the semiconductor thin film can be delayed effectively.

Further, second radiation means 200 according to the present embodiment includes, as described above, irradiance distribution uniformizing means 204. Normally, laser light produced from a laser oscillator has a Gaussian type irradiance distribution in which the irradiance is higher at the center and gradually reduced toward the periphery on a plane perpendicular to the optical axis. Accordingly, when the laser light is used as it is without any processing for heating the glass substrate, the glass substrate may not be heated uniformly, which may leave peripheral portion not being sufficiently heated.

In contrast, according to the present embodiment, since irradiance distribution of second laser light 210 is made uniform using irradiance distribution uniformizing means 204, substantially uniform irradiance can be maintained over the entire radiated area 12. Accordingly, the entire radiated area 12 can be heated uniformly, achieving stable crystallization. Though in the present embodiment the combination of cylindrical lens array and a condenser lens is employed as irradiance distribution uniformizing means 204, it is also possible to employ optical systems using the principle of a kaleidoscope or the like.

### EXAMPLES

In the following, examples based on the present embodiment are described with reference to the drawings.

### Example 1

In the present example, an amorphous silicon thin film is employed as a semiconductor thin film, and XeCl excimer laser light having a wavelength of 308 nm is employed as first laser light. Carbon dioxide gas laser light having a wavelength of 10.6 μm is employed as second laser light.

As shown in FIG. 5, mask 106 used in the present example has a plurality of slits 106a. Slits 106a are arranged by pitch P on the mask and each have width D and length A. A slit-shaped pulsed beam transmitted through slit 106a is radiated to the amorphous silicon thin film at a prescribed magnification.

The area of the glass substrate radiated by the second radiation means is adjusted to include a position corresponding to the entire area of a mask image formed on the main surface of the semiconductor thin film by mask 106.

Using the crystal growth apparatus and the crystal growth method described above, the width of the slit-shaped pulsed beam is adjusted to about 2 μm-50 μm, and XeCl excimer laser light having an irradiance of 500 mJ/cm² was radiated once for radiation period of 50 ns. The inventors confirmed that the length of a crystal grain obtained through this condition reaches up to about 10 μm. This crystal grain in a size of up to about 10 μm is greatly larger than the conventional crystal grain in a size of about 1.2 μm. This is uniquely resulted from uniformly heating the glass substrate at the position corresponding to the area including the crystallization target area by the second radiation means, showing that it is extremely effective means for increasing the length of a grain obtained through a single-time pulse radiation.

However, even the crystal grains each having a length of about 10 μm in the semiconductor thin film is still not large enough in size in some applications as compared to the size of a transistor to be manufactured, and may not be practical to manufacture a transistor with this size.

Accordingly, in order to increase the length of the crystal grain further, the inventors applied the super-lateral growth method using a plurality of times of pulse radiation. In this super-lateral method using a plurality of times of pulse radiation, the laser pulse radiation is applied sequentially so as to overlap part of acicular crystal formed by immediately preceding laser radiation. This allows a longer acicular crystal to grow successively from the crystal that has already grown.

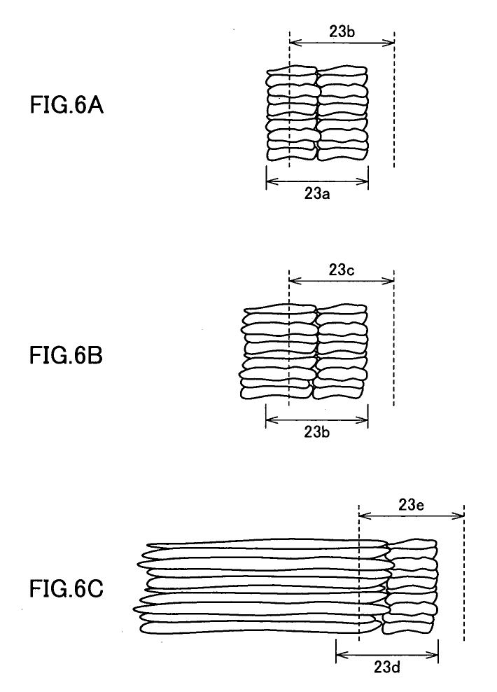

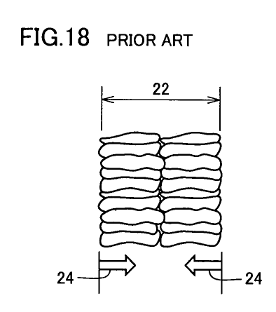

As described above, the super-lateral growth completes by single-time radiation of a pulsed laser (see FIG. 18). On the other hand, as shown in FIGS. 6A-6C, in this case the semiconductor thin film is once radiated with a beam to melt radiated area 23a, it is further radiated with a pulsed laser that is slightly shifted but to overlap radiated area 23a, to melt radiated area 23b. Thus, the crystal grows further at this portion. As shown in FIG. 6B, the semiconductor thin film is radiated with a beam being slightly shifted again, to form radiated area 23c. By forming radiated areas 23d and 23e through repeating slightly shifted radiation, the crystal can be grown further. Specifically, by sequentially applying pulsed laser radiation so as to overlap part of acicular crystal formed by immediately preceding laser radiation, a longer acicular crystal grows successively from the crystal that has already grown, and an acicular crystal grain larger in size and with regular orientation along the growth direction of the crystal can be obtained.

The inventors confirmed that an acicular crystal grain having the length of up to about 50 μm can be formed through performing this plurality of times of laser radiation. This acicular crystal grain in a size of up to about 50 μm is greatly larger than the conventional acicular crystal grain in a size of about 10 μm. This is uniquely resulted from uniform heating of the glass substrate at the position corresponding to the area including the crystallization target area by the second radiation means, the length of a grain obtained through single-time pulse radiation is increased, and the growth of crystal caused by a plurality of times of pulse radiation is repeated more frequently.

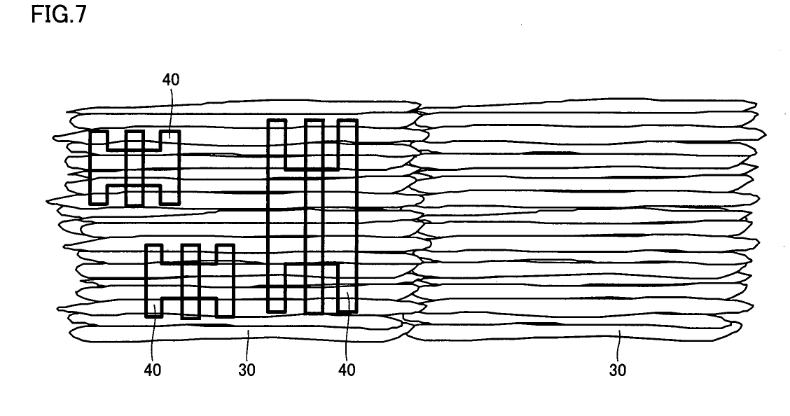

Thus, when the long acicular crystal grain is formed, it is now possible to form a device therein, of which manner is schematically shown in FIG. 7. FIG. 7 shows an example where a transistor 40 having source, drain and channel is formed on an acicular crystal grain 30 being formed long, and the gate for controlling transistor 40 is arranged. Here, by aligning the direction of carriers passing through the channel and the direction of growth of acicular crystal grain 30, scattering by grain boundaries of carriers can be suppressed, whereby the transistor of high performance can be obtained. Specifically, by limiting the arrangement of the transistor to make the channel direction aligned in one direction, a transistor group of high performance can be formed.

### Example 2

In the present example, similarly to Example 1, an amorphous silicon thin film is employed as a semiconductor thin film, XeCl excimer laser light having a wavelength of 308 nm is employed as first laser light, and carbon dioxide gas laser light having a wavelength of 10.6 μm is employed as second laser light. Example 2 is different from Example 1 in the pattern of mask 106 of first radiation means 100.

As shown in FIG. 8, mask 106 used in the present example has apertures 106b-106e. Apertures 106b-106e are each adjusted to be in a shape that generally matches with the size and the position of the channel region of the transistor when their images are formed on the semiconductor thin film.

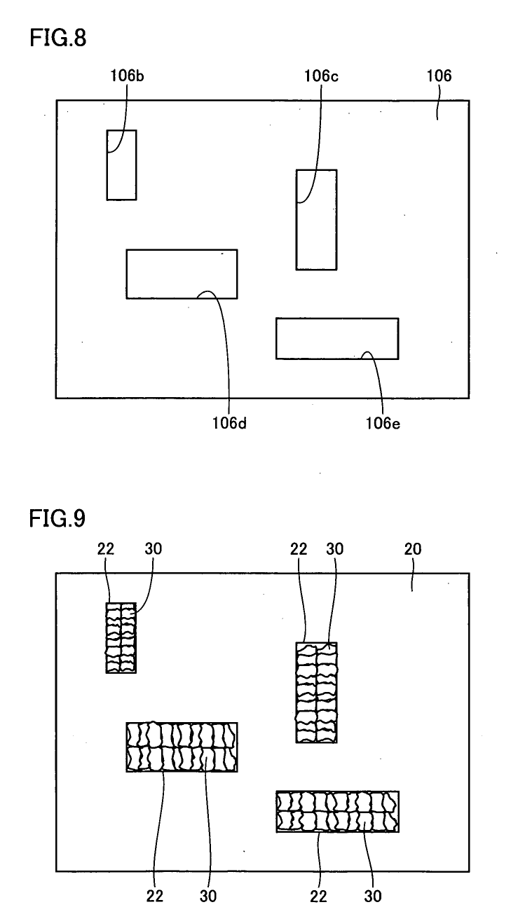

By applying single-time radiation of the first laser light through apertures 106b-106e using the crystal growth apparatus and the crystal growth method as described above, crystallization target area 22 of semiconductor film 20 is melted and solidifies, and crystallization occurs in the process of solidification. At this time, as crystallization takes place from each periphery of apertures 106b-106e, the super-lateral growth takes place toward each center of apertures 106b-106e, as shown in FIG. 9. The size of a crystal grain obtained in this condition is up to about 10 μm, which is substantially equal to the size of the channel region of the transistor.

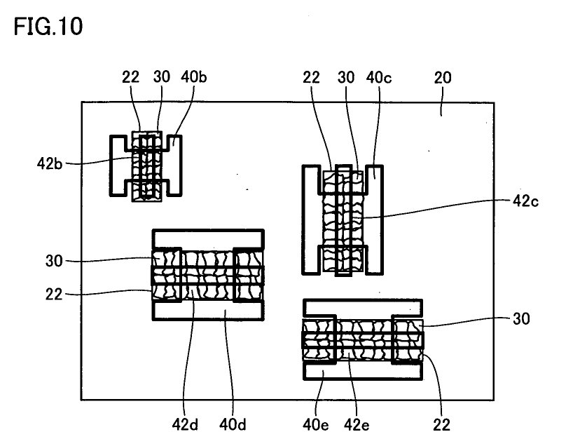

As shown in FIG. 10, each source and drain of transistors 40b-40e are arranged at opposite sides of channel regions 42b-42e, and a gate electrode is arranged above each of channel regions 42b-42e. Here, by employing the arrangement that allows to match the direction of carriers passing through channel regions 42b-42e and the direction of crystal growth of the crystallized area, carriers are less scattered by grain boundaries, and therefore the transistors with extremely high mobility can be obtained. Additionally, by using the mask as in the present example, the arrangement of transistors are no longer limited and thus the transistors can be arranged freely.

### SECOND EMBODIMENT

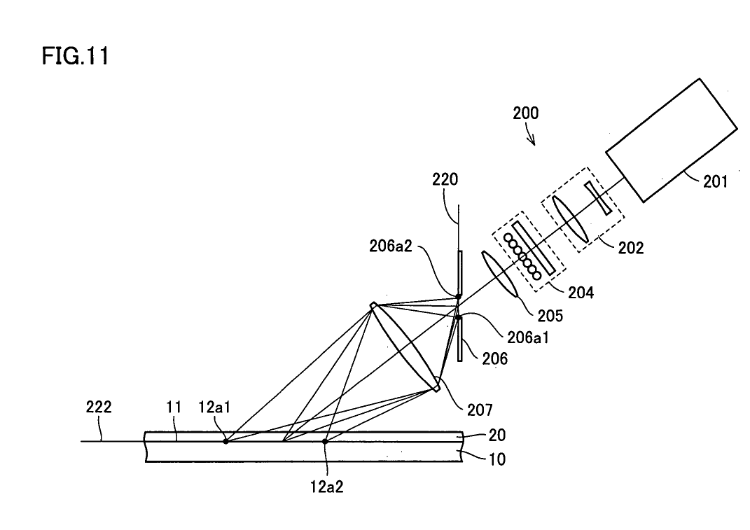

As shown in FIG. 11, a crystal growth apparatus for a semiconductor thin film according to the present embodiment has a configuration substantially similar to that of the first embodiment, and difference from the first embodiment is in the arrangement of the optical systems of the second radiation means. Accordingly, the optical path of the second laser light is also different.

As described above, according to the crystal growth apparatus and crystal growth method for a semiconductor film according to the present invention, it is important to maintain the uniform heating of the glass substrate by the second radiation means over the area radiated by second laser light. However, in the configuration of the second radiation means employed in the first embodiment described above, the second laser light is obliquely incident on the main surface of the glass substrate. Accordingly, when the second laser light is configured to be largely oblique to the glass substrate, the aperture image may not be successfully formed.

This is invited since the distance of the second laser light traveling from the objective lens to the glass substrate varies depending on the point in the objective lens through which the second laser light is transmitted. Thus, the aperture image formed on the main surface of the glass substrate will not focus precisely, and causes the problem that the aperture image is not formed very sharply. When the aperture image is not formed sharply, often not only the contour of the aperture image is blurred, but also the irradiance distribution becomes uneven. This is because the blur of the aperture image is not always symmetric at the front and at the back of the focal plane. As a result, it may be difficult to heat the radiated area uniformly.

Therefore, in the present embodiment, optical systems of second radiation means 200 are arranged as shown in FIG. 11. Specifically, objective lens 207 is arranged to be substantially perpendicular to the optical axis of second laser light 210 that is obliquely incident, and aperture stop plate 206 is arranged oblique to second laser light 210 so that image plane 222 of the aperture image and main surface 11 of glass substrate 10 are substantially overlaid with each other.

In other words, the arrangement of aperture stop plate 206 is changed, from being perpendicular to the optical axis of second laser light 210, to be oblique, such that one end 206a1 of the aperture of aperture stop plate 206 corresponding to imaging point 12a1 positioned on glass substrate 10 that is farther from objective lens 207 becomes closer to objective lens 207, and also the other end 206a2 of the aperture of aperture stop plate 206 corresponding to imaging point 12a2 positioned on glass substrate 10 that is closer to objective lens 207 becomes farther from objective lens 207. Specifically, aperture stop plate 206 is obliquely arranged such that one end 206a1 of the aperture of aperture stop plate 206 forms an image on point 12a1 on glass substrate 10, and the other end 206a2 of the aperture forms an image on point 12a2 on glass substrate 10.

Thus, the contour of the aperture image is sharply formed on glass substrate 10. As a result, the image of the rays of which irradiance is made uniform by irradiance distribution uniformizing means 204 is directly formed on glass substrate 10, it is less likely for the irradiance distribution to be uneven.

Accordingly, as blurred focusing of the aperture image formed on glass substrate 10 is corrected, the aperture image having sharp contour is realized, and it will be possible to heat the radiated area uniformly to the periphery thereof. The angle of obliqueness of aperture stop plate 206 with respect to the optical axis is determined based on geometrical optics, depending on the distance from objective lens 207 to glass substrate 10, the focal length of objective lens 207 or the like.

As in the present embodiment, when second laser light 210 is obliquely incident on the main surface of glass substrate 10 and objective lens 207 is arranged substantially perpendicular to the optical axis of second laser light 210 being obliquely incident, as the distance between objective lens 207 and glass substrate 10 varies among each point in objective lens 207, magnification of the aperture image being formed will vary. As a result, when adjusting the aperture of aperture stop plate 206 to be quadrangular, the aperture image formed on glass substrate 10 will be trapezoidal.

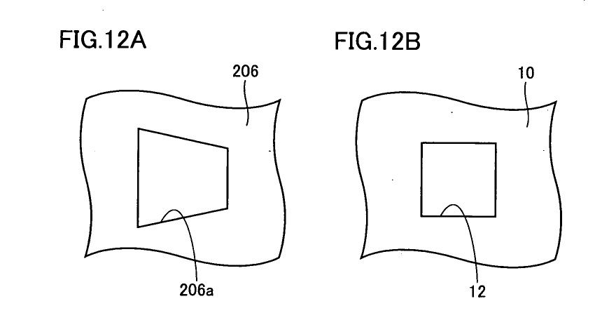

Therefore, it is preferable to form aperture 206a provided to aperture stop plate 206 to be trapezoidal, as shown in FIG. 12A. By forming the aperture image on glass substrate 10 using aperture stop plate 206 having trapezoidal aperture 206a, quadrangular radiated area 12 as shown in FIG. 12B can be obtained.

Thus, by adjusting the radiated area to be quadrangular, the radiated area applied with each pulse radiation may be quadrangular even when the super-lateral growth method using a plurality of times of pulse radiation as described in the Example 1 is employed, the areas will smoothly be connected with each other at their boundaries. As a result, the glass substrate can stably be heated uniformly, and formation of larger crystal grain is facilitated.

### THIRD EMBODIMENT

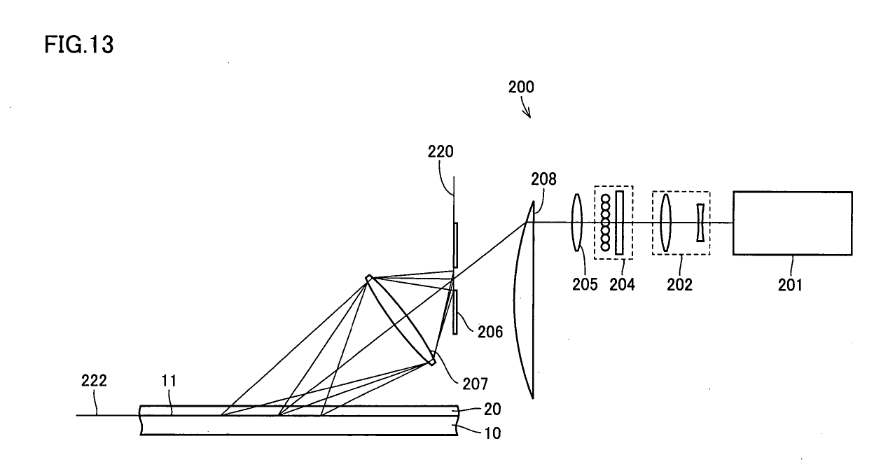

As shown in FIG. 13, in a crystal growth apparatus of semiconductor thin film according to the present embodiment, similarly to the second embodiment described above, objective lens 207 is arranged substantially perpendicular to the optical axis of second laser light 210 being obliquely incident, and aperture stop plate 206 is arranged to be oblique to second laser light 210 such that the image plane of the aperture image substantially overlays main surface 11 of glass substrate 10.

However, when the optical systems are arranged as in the second embodiment, as second laser light 210 is obliquely incident on aperture stop plate 206, irradiance may be uneven at the aperture of aperture stop plate 206. Accordingly, it may be difficult to uniformly heat the entire radiated area of glass substrate 10.

Therefore, in the present embodiment, the optical systems of second radiation means 200 are arranged as shown in FIG. 13. Specifically, a lens 208 as radiation direction changing means is provided between aperture stop plate 206 and field lens 205 such that second laser light 210 of which irradiance distribution is made uniform by irradiance distribution uniformizing means 204 is obliquely incident on aperture stop plate 206. Here, lens 208 is arranged substantially parallel to aperture stop plate 206.

With such a configuration, as the distance from irradiance distribution uniformizing means 204 to aperture stop plate 206 will be the same at any point, unevenness of irradiance distribution is prevented even when aperture stop plate 206 is arranged oblique to the optical axis. As a result, the entire radiated area of glass substrate 10 can be heated uniformly.

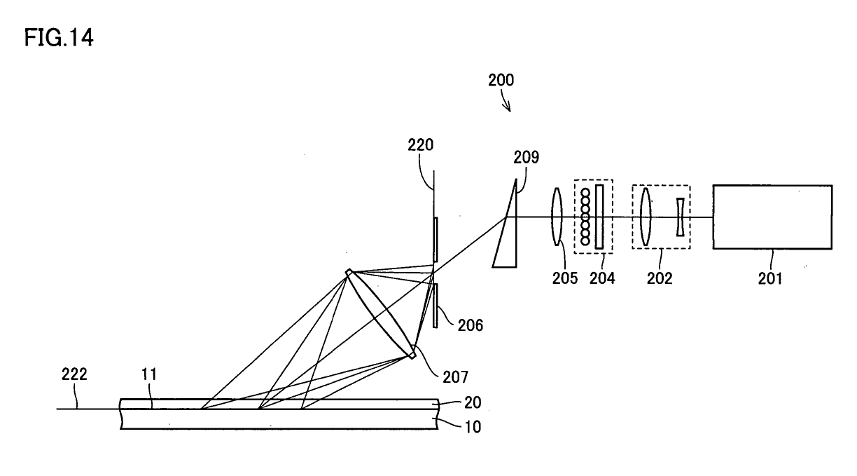

It should be noted that, in the present embodiment, a prism 209 shown in FIG. 14 may be used as the radiation direction changing means. By using prism 209 in place of lens 208 described above, second radiation means 200 can be reduced in size, thus facilitating designing of the apparatus.

### FOURTH EMBODIMENT

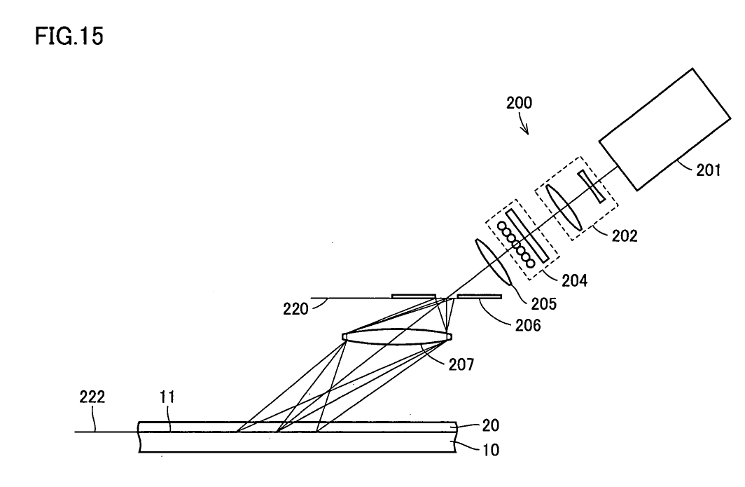

As shown in FIG. 15, similarly to the first to third embodiments described above, in a crystal growth apparatus for a semiconductor thin film according to the present embodiment, second laser light 210 is obliquely incident on main surface 11 of glass substrate 10. However, being different from any of the embodiments described above, objective lens 207 and aperture stop plate 206 are arranged substantially parallel to main surface 11 of glass substrate 10.

With such a configuration, as the distance from aperture stop plate 206 to objective lens 207 will be the same at any point in the aperture formed in aperture stop plate 206, and as the distance between objective lens 207 and glass substrate 10 will be the same at any point, the image formation magnification of the aperture image on glass substrate 10 will be constant over the entire radiated area. Accordingly, the aperture image can be made similar to the aperture of aperture stop plate 206, and glass substrate 10 can be heated uniformly without shaping the aperture in trapezoidal shape.

### FIFTH EMBODIMENT

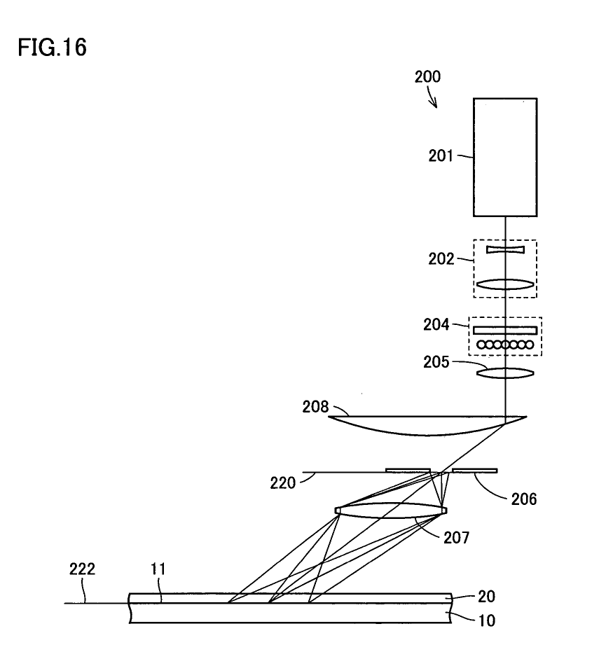

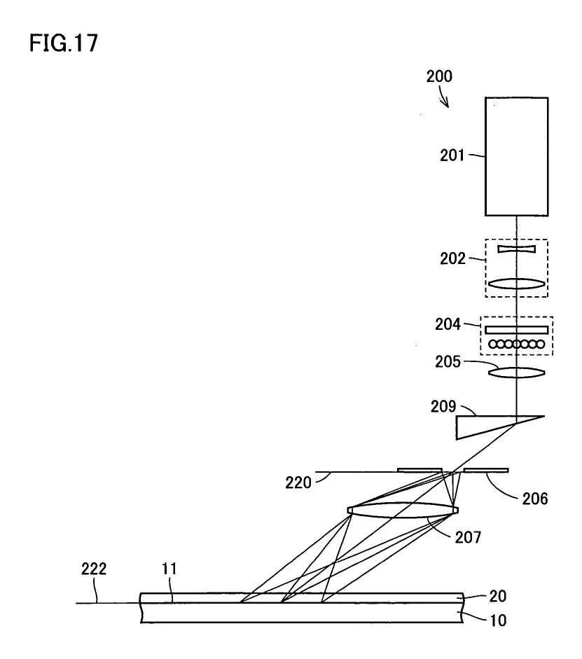

As shown in FIG. 16, similarly to the fourth embodiments described above, in a crystal growth apparatus for a semiconductor thin film according to the present embodiment, second laser light 210 is obliquely incident on main surface 11 of glass substrate 10, and objective lens 207 and aperture stop plate 206 are arranged substantially parallel to main surface 11 of glass substrate 10.

However, when the optical systems are arranged as in the fourth embodiment, as second laser light 210 is obliquely incident on aperture stop plate 206, irradiance may be uneven at the aperture of aperture stop plate 206. Accordingly, it may be difficult to uniformly heat the entire radiated area of glass substrate 10.

Therefore, in the present embodiment, the optical systems of second radiation means 200 are arranged as shown in FIG. 16. Specifically, a lens 208 as radiation direction changing means is provided between aperture stop plate 206 and field lens 205 such that second laser light 210 of which irradiance distribution is made uniform by irradiance distribution uniformizing means 204 is obliquely incident on aperture stop plate 206. Here, lens 208 is arranged substantially parallel to aperture stop plate 206.

With such a configuration, as the distance from irradiance distribution uniformizing means 204 to aperture stop plate 206 will be the same at any point, unevenness of irradiance distribution is prevented even when aperture stop plate 206 is arranged oblique to the optical axis. As a result, the entire radiated area of glass substrate 10 can be heated uniformly.

Further, with such a configuration, as the distance from aperture stop plate 206 to objective lens 207 will be the same at any point in the aperture formed in aperture stop plate 206, and as the distance between objective lens 207 and glass substrate 10 will be the same at any point, the image formation magnification of the aperture image on glass substrate 10 will be constant over the entire radiated area. Accordingly, the aperture image can be made similar to the aperture of aperture stop plate 206, and glass substrate 10 can be heated uniformly without shaping the aperture in trapezoidal shape.

It should be noted that, in the present embodiment, a prism 209 shown in FIG. 16 may be used as the radiation direction changing means. By using prism 209 in place of lens 208 described above, second radiation means 200 can be reduced in size, thus facilitating designing of the apparatus.

Though the shape of the light transmitting portion of the mask of the first radiation means is exemplarily shown as a quadrangular slit in the first embodiment described above, it is not specifically limited thereto and various shapes such as mesh, sawtooth, or corrugated shape can be employed.

Further, though in each embodiment described above, the second laser light has been described as being obliquely incident on the main surface of the semiconductor thin film, it is not specifically limited thereto and it may be configured to be perpendicular to the main surface.

Still further, though in each embodiment described above, it has been exemplary shown to directly form a semiconductor thin film such as an amorphous silicon thin film on a base material such as a glass substrate, a buffer layer may be provided in order to block thermal effect to the base material when the semiconductor thin film is melted, and to prevent impurities in the base material from diffusing into the semiconductor thin film. When a silicon thin film is employed as the thin film, for example silicon oxide film is applicable as the buffer layer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A crystal growth apparatus for a semiconductor thin film for radiating laser light to a semiconductor thin film formed on a base material to cause crystal growth of said semiconductor thin film in a direction substantially parallel to a main surface of said base material, comprising:
first radiation means for selectively radiating first laser light to said semiconductor thin film to melt a crystallization target area of said semiconductor thin film; and
second radiation means for selectively radiating second laser light to said base material to heat said base material at a position corresponding to an area including said crystallization target area of said semiconductor thin film, said second laser light being transmitted through said semiconductor thin film better than said first laser light; wherein
said second radiation means includes a light source for producing said second laser light, an aperture stop plate being radiated with said second laser light to form a desired aperture image, and an objective lens for forming said aperture image on the main surface of said base material.

2. The crystal growth apparatus for a semiconductor thin film according to claim 1, wherein
said second radiation means further includes irradiance distribution uniformizing means arranged between said aperture stop plate and said light source for adjusting said second laser light such that said second laser light being transmitted attains uniform irradiance distribution on a plane perpendicular to its optical axis.

3. The crystal growth apparatus for a semiconductor thin film according to claim 1, wherein
said second radiation means is configured such that said second laser light is obliquely incident on the main surface of said base material,
said objective lens is arranged substantially perpendicular to an optical axis of said obliquely incident second laser light, and
said aperture stop plate is arranged obliquely to the optical axis of said obliquely incident second laser light such that an image plane of said aperture image substantially overlays the main surface of said base material.

4. The crystal growth apparatus for a semiconductor thin film according to claim 3, wherein
an aperture provided to said aperture stop plate is adjusted to be in a trapezoidal shape such that said aperture image formed on the main surface of said base material becomes a quadrangular shape.

5. The crystal growth apparatus for a semiconductor thin film according to claim 3, wherein
said second radiation means further includes irradiance distribution uniformizing means arranged between said aperture stop plate and said light source for adjusting said second laser light such that said second laser light being transmitted attains uniform irradiance distribution on a plane perpendicular to its optical axis.

6. The crystal growth apparatus for a semiconductor thin film according to claim 1, wherein
said second radiation means is configured such that said second laser light is obliquely incident on the main surface of said base material, and
said objective lens and said aperture stop plate are arranged substantially parallel to the main surface of said base material.

7. The crystal growth apparatus for a semiconductor thin film according to claim 6, wherein
said second radiation means further includes irradiance distribution uniformizing means arranged between said aperture stop plate and said light source for adjusting said second laser light such that said second laser light being transmitted attains uniform irradiance distribution on a plane perpendicular to its optical axis.

8. The crystal growth apparatus for a semiconductor thin film according to claim 7, wherein
said second radiation means further includes radiation direction changing means arranged substantially parallel to said aperture stop plate for changing radiation direction of said second laser light such that said second laser light output from said irradiance distribution uniformizing means is obliquely incident on said aperture stop plate.

9. The crystal growth apparatus for a semiconductor thin film according to claim 8, wherein
said radiation direction changing means is a prism.

10. The crystal growth apparatus for a semiconductor thin film according to claim 8, wherein
said radiation direction changing means is a lens.

11. A crystal growth method for a semiconductor thin film for radiating laser light to a semiconductor thin film formed on a base material to cause crystal growth of said semiconductor thin film in a direction substantially parallel to a main surface of said base material, comprising the steps of:
selectively radiating first laser light to said semiconductor thin film to melt a crystallization target area of said semiconductor thin film; and
heating said base material by selectively radiating second laser light to said base material through an aperture stop plate and forming an aperture image shaped by said aperture stop plate on said base material at a position corresponding to an area including said crystallization target area of said semiconductor thin film, said second laser light being transmitted through said semiconductor thin film better than said first laser light.

12. The crystal growth method for a semiconductor thin film according to claim 11, wherein
a radiation period of said second laser light is longer than a radiation period of said first laser light, said radiation period of said second laser light including a period coinciding with said radiation period of said first laser light.
